(19) United States
(12) Patent Application Publication
(10) Pub. No.: US 2002/0103661 A1
(43) Pub. Date: Aug. 1, 2002

(54) System and method for representation of business policy and governing the conduct of business activities using a business rules book

(75) Inventors: Imaddin O. Albazz, Markham (CA); Lev Mirlas, Thornhill (CA)

Correspondence Address: Gregory M. Doudnikoff, IBM Corportaion T81/503, PO Box 12195, Research Triangle Park, NC, 27709, US

(73) Assignee: International Business Machines Corporation, Armonk, NY

(21) Appl. No.: 10/004,076

(22) Filed: Oct. 30, 2001

(30) Foreign Application Priority Data
Oct. 30, 2000 (CA) 2,324,729

(51) Int. Cl. G06F 17/60

(52) U.S. Cl. 705/1

(57) ABSTRACT

A system and method for the representation of business policy and the governing of business activities using a Business Rules Book containing a set of policy and procedural rules. The organization maintains a plurality of stored Policy Sets representing a unique set of Instances of rules selected from the Business Rules Book. The organization establishes the policy and procedural rules under which the various levels and departments in the organization operate using selected Policy Sets designed to address policy and procedural parameters set for each specific business process, user and organization profiles, and optionally linked to a Product List Filter which targets a specific subset of products from a master product list. The Business Rules Book, Policy Set and optionally Product List Filter are linked in a business contract, to create a centrally stored codification of all business policies and procedures, customized to each business deal arrangement with a partner organization. Business activities are executed through the contract as a conduit, which automatically inserts values from the parameters in the contract. Thus, absolute conformity with the terms of the contract is maintained for each business activity undertaken by the organization, and manual administrative activities designed to enforce compliance with the organization's policies and procedures are minimized.

### BACKGROUND OF THE INVENTION

1. Field of Invention

This invention relates to the conduct of collaborative business activities, workflow control and electronic commerce. In particular, this invention relates to a system and method for representing business policies and procedures and governing the conduct of business activities using a business rules book.

2. Description of the Related Art

Business enterprises have developed their own methods of achieving their business goals, even within a particular region or industry. They have created processes and implemented manual systems and computer systems to achieve these goals. As these systems were evolving, enterprises encoded them with bits and pieces of their business policies or “rules”, used to determine the processes implemented by each particular system and control their workflow.

In other words, most business enterprises have scattered or fragmented business policy rules implemented in more than one computer or system, which are connected electronically, or more frequently manually, to achieve the overall enterprise process workflow. Changing an enterprise practice or policy thus often requires amending many application systems, and hence disturbing the workflow balance.

The implementation of business policies occurs in every aspect of the operation of a business. This applies both internally, to processes which the business relies upon for its internal activities workflow, and externally, for example, in the preparation and negotiation of a contract and then in conducting the contractual activities with other partners.

The commercial contract has evolved as a means of developing an ongoing business trust and loyalty between business collaborators. A contract expresses an agreement between trading partners for the execution of contractual activities. Most often the contractual activities will be commercial in nature, however a contract can also be used to govern the conduct of parties in non-commercial activities. The contract becomes the parties' reference in the execution of such activities, as well as legal evidence of the intention of the parties which governs any dispute regarding the activities.

The scattered or fragmented business policy rules under which most business systems operate can present significant administrative problems for an organization executing activities using hundreds or thousands of such policy rules. Internally, organizations may have many levels and departments which have to work together in a cooperative and integrated fashion in order for the business to run efficiently and effectively. Externally, conducting trading with another enterprise, either directly or through an e-marketplace, requires sharing and integrating business processes from both sides as well as sharing some policy rules and data to change or control the process workflow at the collaborating partner's side. Since such information neither originates from nor targets one central system, more integration points and cumbersome technological methods are required to achieve an effective enterprise-to-enterprise business processes molding.

### SUMMARY OF THE INVENTION

The invention overcomes these disadvantages by providing a system and method for the representation of business policy and the governing of business activities using a centrally stored Business Rules Book (BRB). According to the invention, a Business Rules Book maintained by an organization contains a set of policy and procedural rules governing most aspects of the organization's internal and external activities. The organization maintains a plurality of stored Policy Sets, each representing a unique set of rules and policy instances selected from the Business Rules Book. The organization establishes the policy and procedural rules under which the various levels and departments in the organization operate internally and also, the trading and collaboration business activities are conducted, using selected Policy Sets designed to address policy and procedural parameters set for each specific user, group, or trading and collaborating partner. Policy Sets can be incorporated into business contracts when conducting collaborative activities with external partners.

In one preferred embodiment the organization creates an information asset repository that contains links to all or relevant digitized contents that are needed to run the business activities internally or externally. Access to such an information asset repository is controlled using a resource access tool or a directory service like, for example, an LDAP (Lightweight Directory Access Protocol) Directory Service.. The Business Rules Book, Policy Set and optionally a representation form of an information asset repository are linked in a business contract, to create a centrally stored codification of all business policies and procedures, customized to each level and department within the organization and each contracted business deal with collaborating parties.

In the preferred embodiment, business activities are executed through the Policy Set as a conduit, which automatically inserts parameter values and other information assets from data profiles and content repository. Therefore, absolute conformity with the terms and constraints of the Policy Set is maintained for each internal and external business activity undertaken by the organization, and manual administrative activities designed to enforce compliance with the organization's policies and procedures are minimized. Moreover, only those individuals and organizations with proper access privileges within the Policy Set can participate in executing the designated activities.

The Business Rules Book can potentially form the central processes repository and enterprise governor for all industry- or business-specific rules and practices. In the preferred embodiments the invention offers granular components that can be easily customized to support different business models or workflows, and allows flexible access control of the generated entities, such as Policy Instances and Policy Sets.

The system and method of the invention de-fragments and centrally stores all of a business enterprise's policies and rules, which facilitates the implementation of changes within an organization and enhances the efficiency of integration of two or more trading enterprises into a business arrangement. The system and method according to the invention also provides means for facilitating a management control chain through the hierarchy of business personnel, allowing each level of personnel to deal with enhancement to and modification of systems within their respective core competency, while limiting access at each level to the responsible department or personnel.

The present invention thus provides a system for generating a representation of business policy, comprising a computer for: storing at least one compilation of business rules comprising a plurality of rules available to be selected for inclusion in a business contract, storing at least one policy set containing parameters corresponding to selected rules from the compilation of business rules, generating links between the compilation of business rules and the policy set to generate specific rules to be embodied in the business contract, and interlocking the compilation of business rules, the policy set and the links.

The invention further provides a method of generating a representation of business policy, comprising the steps of a. storing at least one compilation of business rules comprising a plurality of rules available to be selected for inclusion in a business contract, b. storing at least one policy set containing parameters corresponding to selected rules from the compilation of business rules, c. generating links between the compilation of business rules and the policy set to generate specific rules to be embodied in the business contract, and d. interlocking the compilation of business rules, the policy set and the links.

Further aspects of the system and method of generating a representation of business policy include: storing at least one product list filter for generating a list of a specified subset of products from a master list of products, and generating links between the product list filter, the policy set and the master list of products; the products list filter comprises a plurality of tiers, each tier generating a list of a different subset of products; the contract comprises dynamic elements which can be altered without modifying the business contract; the products list filter is a dynamic element; and/or the business contract is locked after interlocking contract elements and links.

Further aspects of the system and method of generating a representation of business policy include generating links between the policy set and a repository of enterprise static and dynamic contents. This repository includes, for example, products catalog, documents, web pages, and transactional records. The policy set interlocks business rules with enterprise contents and users and organizations profiles. It also provides the capability to lock this combination to preserve the integrity and accessibility of involved processes and contents.

The invention further provides a system for governing the conduct of business activities over a computer network pursuant to a business contract comprising a predefined set of business rules, comprising a communications interface for receiving information, and a computer for storing the business contract, receiving the information and referencing the business rules in the business contract to process the information.

The invention further provides a method of conducting business activities over a computer network pursuant to a business contract comprising a predefined set of business rules, comprising the steps of: a. storing the business rules, b. receiving information via a communications interface, and c. referencing the business rules in the business contract to process the information.

Further aspects of the system and method for governing the conduct of business activities over a computer network include: generating at least one document processed according to the rules in the business contract; the communications interface displays selected information based on rules in the business contract; and/or providing the business contract with representation criteria comprising product selection criteria or products exclusion criteria, or both, wherein the communications interface displays a filtered products list comprising a subset of products from a master product list

Further aspects of the system and method for governing the conduct of business activities over a computer network include generating at least one document processed according to the rules in a policy set; the communications interface displays selected information based on rules in the policy set; and/or providing the policy set with content filtering criteria comprising links to an enterprise repository of static and dynamic contents.

### BRIEF DESCRIPTION OF THE DRAWINGS

In drawings which illustrate by way of example only a preferred embodiment of the invention:

FIG. 1 is an activity diagram showing the creation and installation of a Business Rules Book in a seller organization;

FIG. 2 is a diagrammatic representation of the relationship between the Business Rules Book and the Policy Set;

FIG. 3 is an activity diagram showing the creation and publication of Policy Instances in a seller organization;

FIG. 4 is an activity diagram showing the creation and storage of a Product List Filter;

FIG. 5 is a diagrammatic illustration of a manner of linking a Policy Set to a multi-tier Product List Filter;

FIG. 6 is an activity diagram showing the governing of the conduct of business activities using as an example the negotiation and preparation of a contract; and

FIG. 7 is a diagrammatic illustration Business Rule Book and Policy Set used in creating an e-commerce contract.

### DESCRIPTION OF THE PREFERRED

The invention provides a system and method for creating a centralized representation of business policy, and for conducting business activities under the centralized representation of business policy.

The preferred embodiment of the invention provides a Business Rules Book, Policy Instances and Sets, and links to user and organization profiles and to contents repository, all of which are integrated to facilitate the central codification of the organization's policies and procedures and the governing of business activities thereunder.

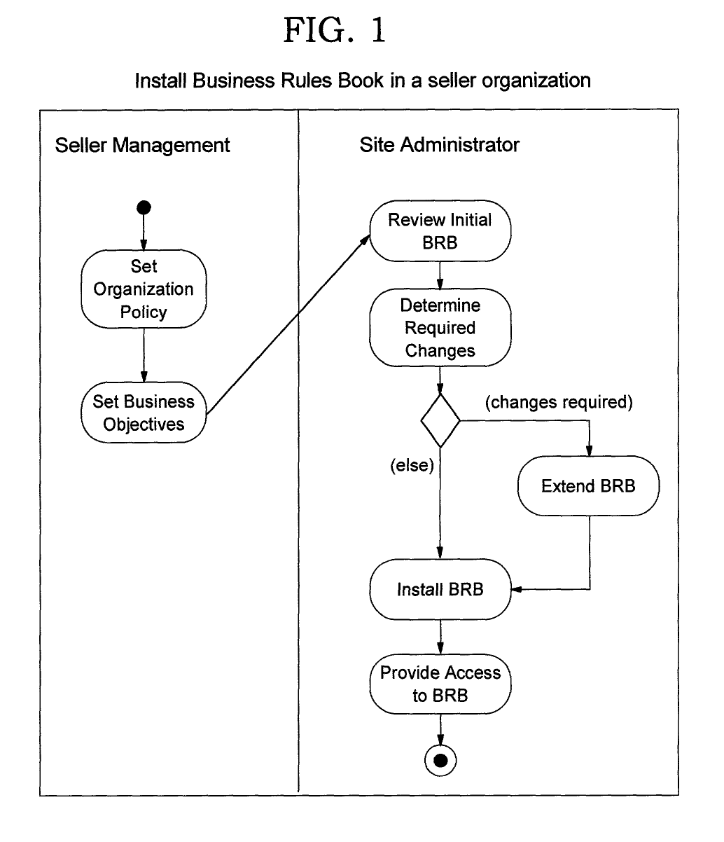

The Business Rules Book (BRB) is an entity which resides on the organization computer system. The BRB is a compilation of business rules which is preferably a centrally-stored codification of all business policies and procedures, industry practices, and the scope, constraints, and characteristics of the organization's business offerings and/or requirements. The BRB is preferably invisible to users within organization who do not have a business justification to work on BRB. FIG. 1 illustrates an example of the creation and installation of a Business Rules Book according to the invention.

The Business Rules Book contains any desired number of “Pages”, which are preferably logically organized into business disciplines that are sensible within the context of the organization's business and industry. For example, separate Pages could be provided for internal processes like supplies and services procurement; contract-specific elements such as pricing and discounts, order fulfillment, billing practices, invoice layout, payment schedules etc.; along with Pages defining industry-specific elements such as group insurance policies, regulatory practices etc. A Page can be further divided into a plurality of “Folds”, by which each Fold inherits the main characteristics of the Page but can also hold its own specific set of parameters. Pages can also be grouped together in an aggregate Page.

Each BRB Page and Fold thus holds a predefined set of parameters, which represent the full spectrum or range of activities undertaken by the organization in the category to which the Page or Fold is directed. Each parameter is linked to a corresponding linking program which executes the required business logic to implement the rules contained within the respective Page or Fold. Linking programs can be written in any language, however rules engines are preferred for their flexibility and ease of use.

An organization requires only one BRB to implement the invention. Once the BRB is in place, it becomes the central source or reference template for all allowed and supported practices and policies within the organization. The BRB is customizable and can be updated and/or extended by the organization. While BRB changes would not be expected to be a frequent operation practice, since no business would ordinarily change their business practices too frequently, the BRB offers sufficient flexibility for the organization to amend business rules and introduce new business rules in response to market changes and internal demands. This is done either by updating specific pages or folds or by inserting new pages to the BRB. New pages can be developed either in-house or by a solution provider. In the preferred embodiment, BRB Pages are implemented only by personnel granted access to a BRB modification interface.

From a software developer perspective, the BRB can be designed with a certain industry focus in mind. For example, a BRB can be specific to the health care industry, government, manufacturing or any other industry vertical.

The BRB is used in conjunction with Policy Instances. Each Policy Instance represents a set of specific Instances of Pages in the Business Rules Book. The Policy Instances are created by the organization, which may involve input from personnel of all types within the organization, for example a sales or business development administrator. Like the BRB, the Policy Instances can also be considered to consist of Pages. Each Page of the Policy Instances corresponds to a Page in the Business Rules Book, and provides the appropriate execution parameters for the BRB Page logic. For example, if the BRB page contains logic to determine allowable discounted prices, the corresponding Policy Instance would set the discount percentage, for example based upon permissible discounts that can be offered by the personnel making the offer.

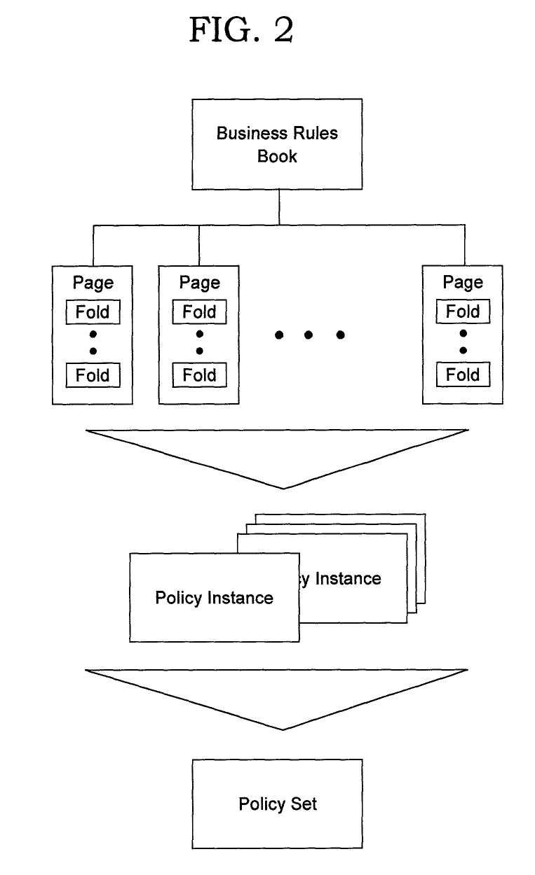

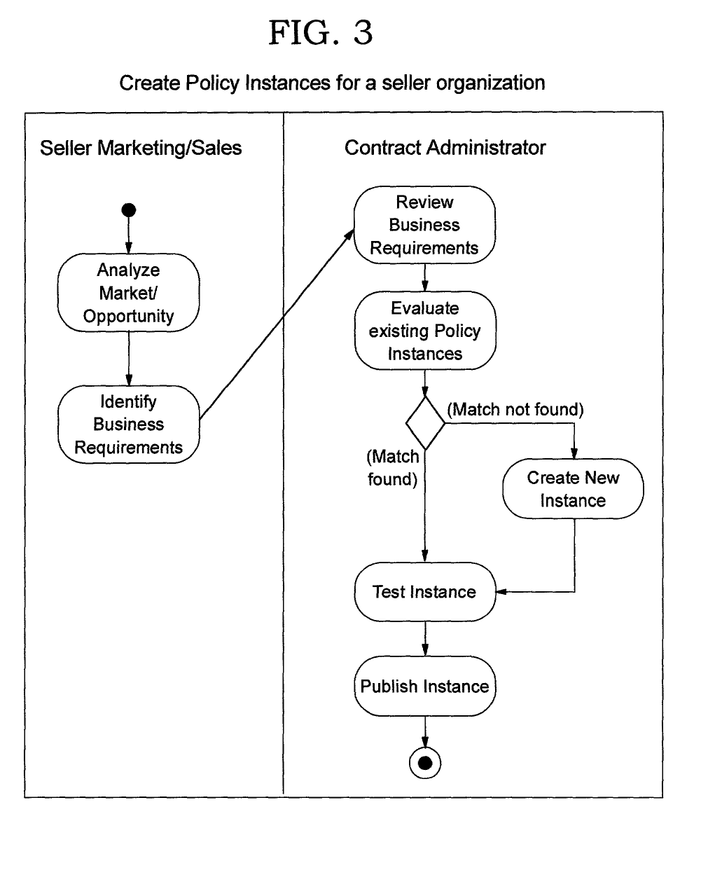

The Policy Instances combine to generate a specific Policy Set within the parameters established by the BRB, which is customized to each level, department and even (if desired) employee within the organization. FIG. 2 illustrates the hierarchical relationship between the Policy Set and the BRB. FIG. 3 illustrates an example of the creation and publication of Policy Instances in a seller organization, by way of example.

The preferred embodiment of the invention provides for the creation of many different Policy Sets using the Business Rules Book. Each Policy Set represents an integrated set of policies and procedures applicable to the target group, which may be categorized by level, department, personnel type, partnership terms etc., within the organization and with other parties.

In the preferred embodiment each Policy Set contains the following information: Policy Set and Rules identifiers or reference numbers; Rules short description; Rules Status (Active, Published, Restricted, Test, Expired); links to applicable non-structured text attachments; dates for Rules creation, start, expiry; Pages designed for the targeted store business and industry; and Policy Set parameter values for all Pages and Folds.

Each Policy Set created from the Policy Instances, which reference the Business Rules Book, is an independent and unique entity which may be applied to a specific internal department or even individual employee or to a specific partnership contract with one or more external organizations. Policy Instances, however, may be shared by different Policy Sets.

In the preferred embodiment, when a new Policy Set is first created by an organization it is assigned a ‘Test’ status and becomes accessible only to the creator and other personnel within the organization having the required system access privileges, to allow for proper verification (and optionally management approval) of the new Policy Set, for example as to pricing, document formatting etc., before implementation. Once testing is over and the new Policy Set has received any required approvals, the status of the Policy Set is changed to ‘Active’ and the Policy Set can be implemented by the organization.

The exact structure and contents of a Policy Set and its interlocked links would depend on the targeted audience and activities. Since Policy Sets can serve both internal users of an organization as well as an organization customers and partners, the contents and links for Policy Sets can vary in complexity and structure. However, the concept and implementation of the Policy Sets remains the same.

The following description will introduce a sample implementation of a Policy Set which is used in generating and e-commerce business-to-business contract between a seller and a buyer trading parties.

Trading with other parties requires sharing and exchanging information assets, or contents, often as an integral part of the business transactional activities. Such contents may need to be customized, or personalized, to the parties' specific deal under which the business activities are being conducted.

In the preferred embodiment partners' trading and collaboration will be governed by a business contract. This contract will comprise a unique Policy Set with proper links to system access controls, user and organization profiles, and information asset repository which includes all static and dynamic contents that need to be exchanged between the collaborating and trading parties.

In essence, the Policy Set in this sample implementation encompasses all contractual terms and conditions between the seller and buyer organizations.

A key element of the contents exchanged in e-commerce partnerships is the eligible products and/or services list.

The preferred embodiment of the invention uses the Product List Filter (PLF) as a static representation of the dynamic products and services list which needs to be included in a long term trading and collaboration business contract.

A static element is an element that, once approved for publishing, is unlikely to change. Any subsequent change to a static element would require re-approval. A dynamic element is an element that will inevitably change, for example a selling organization's product lists which may change with the addition of new products, the discontinuation of old products, or simply the revision of product descriptions; or price list, which may change with inflation or other factors. The implementation of dynamic elements allows a selected degree of flexibility within an organization, to make changes to the organization's current policies and procedures independent of the Business Rules Book and Policy Instances. An example of a dynamic element is the Product List Filter, described below.

Content filtering based on certain parameters or content values is similarly applicable in other implementations of the invention which may not include products or services list, but rather a collection of static and dynamic contents assets from a central contents repository.

Access control may optionally be introduced to restrict the accessibility to and use of Policy Sets. Policy Instances may be restricted by the organization to a certain level, department, group of employees, and a Policy Set may be restricted to a single or a group of internal or external individuals or organizations. Policy Sets may be linked to one or more Product List Filters, as described below.

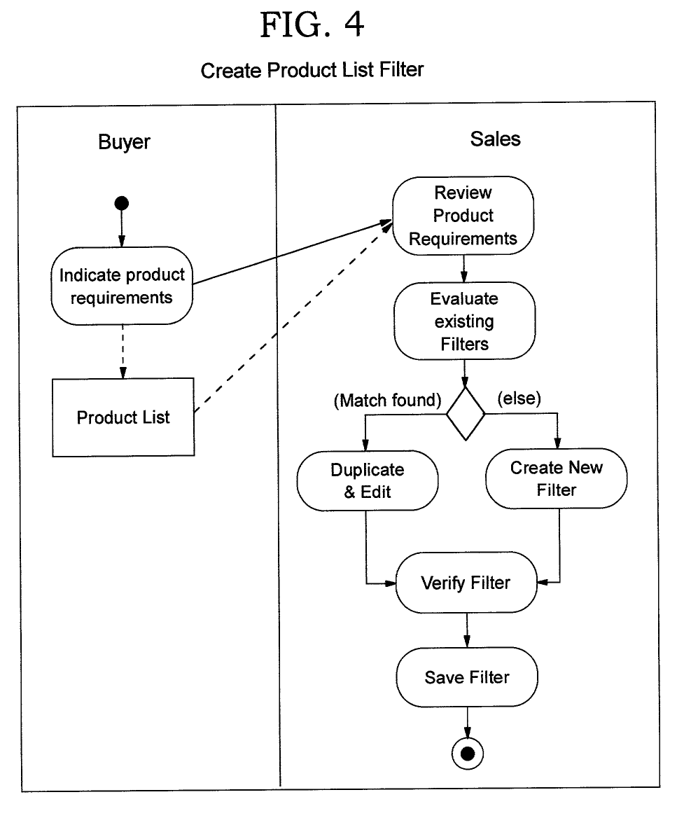

A Product List Filter (PLF) is a representation of the organization's product list which replaces the complete list of all products available from the organization (as used herein the term “products” includes both products and services). This representation comprises products selection and/or exclusion criteria, based on a selection metaphor. The representation criteria are structured and stored in a way that ensures rebuilding the targeted product list from a master content repository or a product catalog, or from multiple catalogs or other product information sources, any time the target product list is required. Depending upon the used PLF, a generated list could be static with the same products being produced at every run, or could be dynamic with new products being added or removed according to changes taking place at the seller organization. FIG. 4 illustrates an example of the creation and storage of a Product List Filter.

Different tools can be adapted to create Product List Filters, for example commercially available tools commonly known as configurators, however the configurator should be capable of saving and reusing a created PLF. The PLF is stored under a unique identifier or reference number, and becomes the products element representation available to be offered to prospective buyers by the seller organization. The PLF can thus be considered to be an extension of the Policy Instances, in the sense that it is an instance (an agreed to subset of products) which governs the breadth of products exposed to the buyer. However, the PLF is advantageously constituted as a separate entity because it will typically advantageously be a dynamic element, capable of modification at the instance of executives or others within the organization having the requisite access and permissions.

A PLF can be extended into multi-tier configuration where each tier holds a logical division of the targeted product set domain. Each tier of a multi-tier PLF has its own sub-identification, which is hierarchically linked to the main PLF identification. When a PLF is referenced, all products from the related tiers within that PLF are included. However, when a tier sub-identification is referenced, products from other tiers in the same PLF are excluded.

PLFs can be implemented within the organization in different scenarios. For example, a seller organization may define a product list to be offered to a particular buyer and create a specific PLF for that list, which is used by a contract preparation administrator to prepare the contract. In another example, seller and buyer representatives negotiate and agree on a targeted list of products, which is then reverse engineered by the seller to create a PLF. In each case, once a product list (which may be framed more broadly as a list of product categories) is agreed to and approved it will be defined by a corresponding PLF which becomes an integrated component of the contract. This eliminates the need to include an actual product list in the contract, and offers the flexibility required to generate a dynamic product list that can be refreshed with new products whenever the seller decides that such new products should be made available.

A seller can define one or more PLFs that can be linked to published Policy Sets which, in turn, are linked to certain user or organization profiles, thus controlling the content of the product list on a user or buyer organization basis. The specified PLFs enforce the products viewable by any particular buyer organizational group in the aspect of the invention which governs the conduct of business activities, discussed below, whenever a member of the buyer group accesses the seller organization's system resources. The buyer can then select or search for required products from the filtered version of the organization's master product list.

The Business Rules Book and Policy Set are tied together under the business contract, which includes linking any Product List Filter(s) and user and organization profiles. FIG. 5 illustrates an example of linking a Policy Set having a multiple Folds to a multiple-tier PLF. A similar scenario applies when linking Policy Set Folds to different divisions or departments within an organization profile.

According to the preferred embodiment of the invention, the business contract then becomes the core of all business activities undertaken within the organization.

When the required approvals of the business contract have been obtained, the contract elements are linked, locked, and saved in the organization's central computer system. Authorized personnel can view the contract, however any changes to any static content element, Policy Set or PLF would require contract re-approval by authorized personnel. Changes to the contents of a dynamic element, for example where updates are made by the seller to the master product catalog contents which include product categories within a PLF, do not require re-approval since the impact of these changes is shielded by the PLF and such changes are contemplated by the contract.

When activated, an approved contract becomes the central business control component in the business activity aspect of the system and method of the invention. All other integrated processes reference the contract and related subsystems whenever a business activity is initiated. In effect, the contract becomes a processing entity through which business activities undertaken within the organization are routed, as illustrated in FIG. 7.

The contract, Policy Set and Product List Filter are used by the computer systems to determine the contents, process flow, and ‘look and feel’ of an organization's e-commerce system from the target buyer individual's or group's perspective. The organization maintains one copy of a master product catalog, or a group of catalogs, and by using different Policy Sets combined with selected Product List Filters, the organization can create unlimited one-to-one customized user interfaces for each different level, department or other group, or even employee, within the organization and for each single partnership relation with each partner.

Moreover, for each business activity executed under the contract, the terms and constraints of the activity are imported into transaction documentation from the Policy Set, which is an integral part of the contract itself, thus avoiding both the administrative burden of ensuring compliance with the contract and the interposition of human error or oversights which may occur through manual administration. In each activity, business forms in a format previously approved are generated automatically from the content repository elements linked to from within the contract. Dynamic elements such as the PLF are maintained fully up to date by virtue of the organization's background maintenance and updating of catalogs and other product information, and all policy instances of the BRB specific to the particular division, group etc. are incorporated into the transaction documentation without manual intervention.

To implement the system of the invention the seller organization creates a BRB, which may be prepared by the seller in-house, refined from templates or precedents provided by an outside provider and supplied to the organization, or outsourced through an ASP (Application Service Provider). Once approved the BRB, containing all management approved policies and practices, is published by the organization and installed in the central or hosted computer system.

Using the BRB as a guide, the organization's administration staff, with the necessary direction from marketing, finance and any other involved departments or divisions, creates test Policy Instances and Sets for approval by management, and ultimately publishes a collection of approved Policy Sets each specifying respective sets of Policy Instances representing specific Pages of the organization's BRB. The organization also compiles a product catalog, or a group of catalogs or other product information sources, featuring the complete list of products to be made available to internal and external users, preferably identifying one or more product categories for each product.

If it is determined that the existing BRB is not flexible enough to generate practical or effective Policy Sets, management can initiate the process of adding new pages to the BRB or extending or amending existing BRB Pages (the Policy Instances, being a set of specific rules from within the range permitted by the BRB, cannot offer terms or conditions outside the scope of the BRB).

When final revisions of a contract are approved, all contract elements are interlocked by the organization's administration staff to prevent unauthorized changes to the contract.

Contracts are either automatically activated by the system upon interlocking of contract elements, or manually published (i.e. set to an ‘Active’ state by the administrator). Active contracts are exposed to systems within the organization, including e-commerce subsystems such as order management, fulfillment, billing and payment, services, etc. The contract PLF determines which products from the master product list sources are made visible to buyer personnel.

The system and method according to the invention thus provide means for facilitating a management control chain, through the hierarchies established by the BRB and BRB Pages/Folds, Policy Instances and Policy Sets, and optionally PLFs and PLF Tiers and user and organization profiles. This allows businesses to maintain control over the content and format of documents, and other business activities, through the hierarchy of their personnel. For example, executives can determine the basic rules for the BRB, while marketing managers can control the implementation of Policy Instances relating to marketing, accounting managers can control the implementation of Policy Instances relating to accounting, etc. Access privileges to the various contract elements can be restricted (as to visibility, use/and or modification) according to the level of personnel responsible for each respective element. Similarly, different departments or other groups within or outside an organization may have access to different tiers of a PLF, or different Policy Sets. This enables a business to operate efficiently, consistently, and within the boundaries accorded to each level of the organization by the applicable Policy Set or contract.

The system and method of the invention also improve the control of workflow within an enterprise and between trading partners, through interaction between the BRB and Policy Instances. Rules can be invoked by the BRB according to the Policy Instances parameters and the step reached in a workflow process (for example as determined by the occurrence of a prior event), and Policy Instances can thus direct workflow processes differently in the case of contracts which embody different Policy Sets.

Preferred embodiments of the invention having been described by way of example only, it will be appreciated that various modifications and adaptations of the invention may be made without departing from the scope of the invention, as set out in the appended claims.

The embodiments of the invention in which an exclusive property or privilege is claimed are defined as follows:

1. A system in a computing environment for generating a representation of business policy, comprising:
means for storing at least one compilation of business rules comprising a plurality of rules available to be selected for inclusion in a business contract;
means for storing at least one policy set containing parameters corresponding to selected rules from the compilation of business rules;
means for generating links between the compilation of business rules and the policy set to generate specific rules to be embodied in the business contract; and
means for interlocking the compilation of business rules, the policy set and the links.

2. The system as defined in claim 1, further comprising:
mean for storing at least one product list filter for generating a list of a specified subset of products from a master list of products; and
means for generating links between the product list filter, the policy set and the master list of products.

3. The system as defined in claim 2, wherein the product list filter comprises a plurality of tiers, each tier generating a list of a different subset of products.

4. The system as defined in claim 2, wherein the business contract comprises dynamic elements which can be altered without modifying the business contract.

5. The system as defined in claim 4, in which the product list filter is a dynamic element.

6. The system as defined in claim 1, wherein the business contract is locked after interlocking contract elements and the links.

7. A method of generating a representation of business policy, comprising the steps of:
a. storing at least one compilation of business rules comprising a plurality of rules available to be selected for inclusion in a business contract;
b. storing at least one policy set containing parameters corresponding to selected rules from the compilation of business rules;
c. generating links between the compilation of business rules and the policy set to generate specific rules to be embodied in the business contract; and
d. interlocking the compilation of business rules, the policy set and the links.

8. The method as defined in claim 7, further comprising the steps of:
e. storing at least one product list filter for generating a list of a specified subset of products from a master list of product; and
f. generating links between the product list filter, the policy set and the master list of products.

9. The method as defined in claim 8, wherein the product list filter comprises a plurality of tiers, each tier generating a list of a different subset of products.

10. The method as defined in claim 8, wherein the business contract comprises dynamic elements which can be altered without modifying the business contract.

11. The method as defined in claim 10, in which the product list filter is a dynamic content element.

12. The method as defined in claim 7, wherein the business contract is locked after interlocking contract elements and the links.

13. A system for governing conduct of business activities over a computer network pursuant to a business contract comprising a predefined set of business rules, comprising:
a communications interface for receiving information; and
means for storing the business contract;
means for receiving the information; and
means for referencing the business rules in the business contract to process the information.

14. The system as defined in claim 13, further comprising means for generating at least one document processed according to the business rules in the business contract.

15. The system as defined in claim 13, wherein the communications interface displays selected information based on the business rules in the business contract.

16. The system as defined in claim 15, wherein the business contract contains representation criteria comprising product selection criteria or products exclusion criteria, or both, and the communications interface displays a filtered products list comprising a subset of products from a master product list.

17. A method of conducting business activities over a computer network pursuant to a business contract comprising a predefined set of business rules, comprising the steps of:
a. storing the business rules;
b. receiving information via a communications interface; and
c. referencing the business rules in the business contract to process the information.

18. The method as defined in claim 17, comprising the further step of:
d. generating at least one document processed according to the business rules in the business contract.

19. The method as defined in claim 18, wherein the communications interface displays selected information based on business rules in the business contract.

20. The method as defined in claim 19, further comprising the step of:
e. providing the business contract with representation criteria comprising product selection criteria or products exclusion criteria, or both, wherein the communications interface displays a filtered products list comprising a subset of products from a master product list.
